(19) United States
(12) Patent Application Publication
(10) Pub. No.: US 2011/0091034 A1
(43) Pub. Date: Apr. 21, 2011

(54) Secure Method for Cryptographic Computation and Corresponding Electronic Component

(75) Inventor: Yannick Teglia, La Bouilladisse (FR)

(73) Assignee: STMicroelectronics (Rousset) SAS, Rousset (FR)

(21) Appl. No.: 12/907,755

(22) Filed: Oct. 19, 2010

(30) Foreign Application Priority Data
Oct. 20, 2009 (FR) 09-57343

(51) Int. Cl. H04L 9/28

(52) U.S. Cl. 380/29

(57) ABSTRACT

The secure method for cryptographic computation comprises processing of an input datum (D) by a cryptographic computation tool involving at least one encryption key (K) and at least one generated item of secret information, so as to provide an output datum (DC). The generation of the said at least one item of secret information (ST) comprises processing of the said input datum by at least one operator (OPS) having at least one secret characteristic.

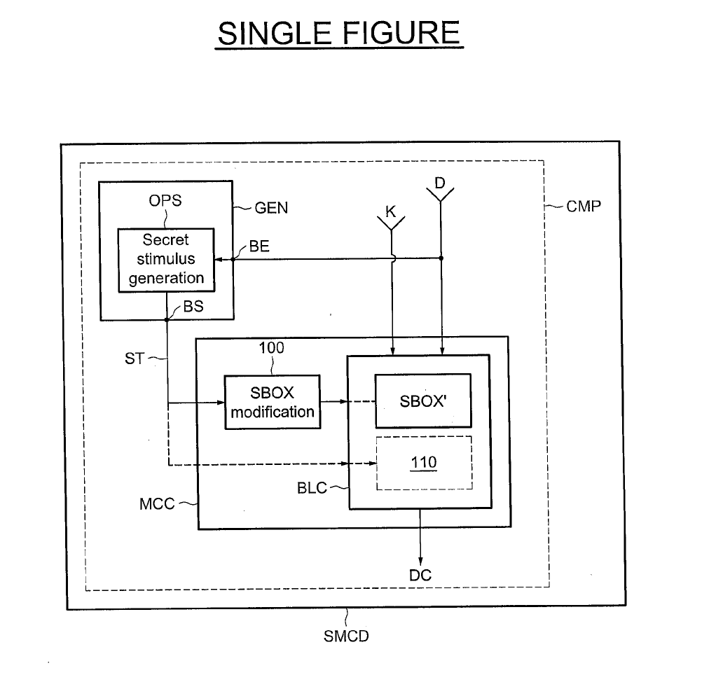

This application claims priority to French Patent Application 09-57343, which was filed Oct. 20, 2009 and is incorporated herein by reference.

### TECHNICAL FIELD

The invention relates to the protection of cryptographic computations, notably but not exclusively those carried out in smart cards.

The invention relates more particularly to the protection of the cryptographic computation tools against what are known in the art as “template attacks”, and more particularly the cryptographic computation tools that have already been protected against attacks using a differential analysis of consumption, and well known to those skilled in the art as “Differential Power Analysis” (DPA).

### BACKGROUND

Smart cards interact with the external environment in a producer/consumer mode. For example, a smart card consumes energy drawn from an electric power supply and produces electromagnetic radiation. The electric consumption and the electromagnetic radiation are correlated since the electromagnetic emission depends on the consumption of energy. Moreover, it is known that the electric consumption of a device is also an image of the processing operations carried out inside this device. Consequently, the analysis of consumption may reveal a code and data of an electronic device when the latter is operating. These data may be secret data such as for example a secret key used in a cryptographic computation.

For the purpose of determining secret keys, smart cards are susceptible to being the subject of several types of attacks. Amongst the latter, the attacks called DPA attacks are based on the study of the correlations between an intermediate variable of the cryptographic software implemented in the electronic component and the electric consumption values of this component. Such statistical attacks have shown that they were more effective than the conventional attacks based on a single consumption analysis such as for example attacks of the SPA (Single Power Analysis) type.

In order to thwart such DPA attacks, counter-measures have been developed which consist in breaking the said correlations. More precisely a secret random element is inserted into the algorithm so that two identical processes with the same datum will supply different current consumptions because of the use of these random elements. The random numbers are mixed with the data (optionally with the secret key) before the processing, which also requires a software or hardware modification of the original cryptographic tool, and then, the processing is carried out on the randomized data. Because of this, the statistical analyses no longer show the correlation and the attacks of the DPA type then become ineffective.

This being so, new types of attacks have been developed consisting in thwarting the random number generator. These attacks, known to those skilled in the art as “template attacks” aim to characterize the random number generator either before the encryption step or during this encryption step in order to determine for example at least certain of its defects, such as for example the skew which differentiates it from a theoretically perfect random number generator.

Such attacks require the fraudster to have access to the blank component (that is to say not containing any key or data) or to an identical experimental component, or else to a component of the same family incorporating a comparable random number generator which the fraudster can then program as required. Therefore, the fraudster can take measurements by various means to obtain a template of the random number generator.

Then, during the encryption phase carried out by the cryptographic software implemented in the component, he carries out the same encryption n times, that is to say by using one and the same key and one and the same datum. In this way the only modification during the encryption phase results in the random numbers used. By taking a very large number of measurements and knowing for example the skew and other characteristics of the random number generator, the mean value of the consumption curves obtained for the said key and the said datum provides a benchmark curve. Reiterating these operations for different values of keys and of data therefore gives a set of benchmark consumption curves or “templates” which can therefore be used during analysis of the consumption curve of the real component so as to be able to find the secret key that it contains.

### SUMMARY OF THE INVENTION

In one aspect, embodiments of the present invention provide for a secure method for cryptographic computation, comprising processing of an input datum by a cryptographic computation tool involving at least one encryption key and at least one generated item of secret information, so as to provide an output datum, characterized in that generation of said at least one generated item of secret information comprises processing of said input datum by at least one operator having at least one secret characteristic. In another aspect, embodiments of the present invention provide for an electronic component comprising a first input for receiving an input datum and a second input for receiving an encryption key. The component further comprises a secret stimulus generator, configured to receive said input datum and to generate at least one item of secret information and an encryption engine, configured to receive said input datum, said encryption key, and said at least one item of secret information and to generate an encrypted datum therefrom by processing said input datum by at least one operation using said at least one item of secret information.

### BRIEF DESCRIPTION OF THE DRAWINGS

For a more complete understanding of the present invention, and the advantages thereof, reference is now made to the following descriptions taken in conjunction with the accompanying sole drawing which schematically illustrates an embodiment of the present invention.

### DETAILED DESCRIPTION OF THE EMBODIMENTS

Before providing a detailed description, embodiments of the invention will be described generally. According to one method of application and embodiment, a method for cryptographic computation and a component are proposed that aim to make attacks of the “template” type more difficult, in particular by reducing the possibility for the attacker to generate benchmark curves or templates relating to the secret data.

According to another method of application and embodiment, also proposed is the possibility of removing the random number generators which, as analogue components, are difficult to characterize and keep uniform in terms of behavior during modifications of process or of manufacture.

Therefore, according to one method of application, use will be made of what the attacker knows, for example the input datum, in order to generate a secret stimulus so that the execution a great number of times of the encryption algorithm with one and the same datum and one and the same key value always gives the same secret stimulus, which will consequently render any averaging useless for a potential attack.

According to one aspect, a secure method for cryptographic computation is proposed comprising processing of an input datum by a cryptographic computation tool involving at least one encryption key and at least one generated item of information in order to provide an output datum.

According to a general feature of this aspect, the generation of the said at least one item of secret information comprises processing of the said input datum by at least one operator having at least one secret characteristic.

Therefore, it is possible, for example, to remove the random number generator as the producer of the secret datum and replace it with a deterministic process, that is at least partly secret, and supplied by the input datum itself which is known to the attacker. And it is this deterministic process through its at least partly secret character, which generates the item of secret information. The generation of an item of secret information specifically remains necessary in order to counter attacks of the DPA type, but its vulnerability is in this instance considerably reduced. Specifically, even if one and the same input datum is delivered several times, the result thereof will be the generation of an item of secret information which will be identical every time. And, consequently an averaging operation is no longer of any value for the attacker during the encryption phase of the cryptographic tool.

According to one method of application, the said at least one operator may comprise a function that is at least partially secret having an avalanche effect and capable of providing respectively, based on different input variables, output variables that are independent and substantially uniformly distributed.

The operator can therefore comprise an at least partially secret hashing function.

The cryptographic computation tool may result from a modification of a known cryptographic computation tool, the said modification involving the said at least one item of secret information.

This cryptographic computation tool may comprise an encryption algorithm with a secret key of the DES or AES type.

According to another aspect, an electronic component is proposed comprising means for generating at least one item of secret information and means for cryptographic computation configured to receive an input datum and to deliver an output datum based on the said input datum, of at least one encryption key and of the said at least one item of secret information.

According to a general feature of this aspect, the generation means comprise input means for receiving the said input datum, output means for delivering the said at least one item of secret information, and at least one operator coupled between the input means and the output means and comprising at least one secret characteristic.

According to one embodiment, the said at least one operator comprises an at least partially secret function having an avalanche effect and capable of providing respectively, based on different input variables, output variables that are independent and substantially uniformly distributed.

According to one embodiment, the said operator comprises an at least partially secret hashing function.

According to one embodiment, the cryptographic computation means result from a modification of a known cryptographic computation means, the said modification involving the said at least one item of secret information.

According to one embodiment, the cryptographic computation means comprise an encryption algorithm with a secret key of the DES or AES type.

According to another aspect, a smart card is proposed incorporating a component as defined above.

Other advantages and features of the invention will become apparent on examination of the detailed description of methods of application and embodiments, which are in no way limiting and of the appended drawings, in which the single FIGURE illustrates schematically an embodiment of a component according to the invention allowing a method of application of a method according to the invention.

The reference CMP designates an electronic component incorporating cryptographic computation means MCC. In the example described here, the cryptographic computation means MCC receive as an input a datum D and a secret key K and provide as an output an encrypted datum DC. In a manner that is conventional and known per se, the key K is secret because it is for example stored in a protected memory of the component CMP.

The component CMP is for example inset into a smart or micro chip SMCD commonly called a “smart card”.

The cryptographic computation tool used by the means MCC is in this instance for example, an algorithm of the DES (Data Encryption Standard) or AES (Advanced Encryption Standard) type which are well known to those skilled in the art. Such cryptographic computation tools usually use non-linear operators commonly designated by those skilled in the art under the reference SBOX. Here again, the structure of such non-linear operators is perfectly well known per se.

This being so, in order notably to randomize intermediate variables used in the cryptographic computation, the linear operator SBOX can be modified with the aid of a secret stimulus ST (step 100) so as to provide a modified or masked linear operator SBOX′.

In order to obtain as an output from the computation block BLC using the cryptographic computations, an encrypted datum DC identical to that which would have been obtained with an unmodified cryptographic computation tool, it is possible to carry out an unmasking of the masked intermediate keys with the secret stimulus ST and/or a final unmasking of the datum before delivery by the computation block. This or these unmaskings, indicated generally by the reference number 110 can be carried out in a conventional manner by one or more specific unmasking operators or else by one or more other SBOX boxes provided for this purpose.

As an indication but not a limitation, the modification of the cryptographic computation tool and the unmasking operation or operations may be carried out on the key path as for example described in European patent No. 1 358 733, and/or on the data path as for example described in European patent No. 1 358 732.

The secret stimulus ST is generated by an operator OPS of generation means GEN which receive as an input BE the input datum D.

Since the input datum is by definition known, it is therefore necessary, for the stimulus ST generated at the output BS of the generation means to be secret, for the operator OPS used within the generation means GEN to have at least one secret characteristic.

This secret characteristic may result for example from a secret implementation, within the integrated circuit supporting the component CMP, of at least a portion of the operator used within the generation means.

Although it is possible to use many types of operators within the generation means GEN, it is particularly worthwhile to use a function having an avalanche effect (that is to say that the modification of one bit at the input of the function modifies on average half of the output bits) and capable of providing respectively, based on different input variables, output variables that are independent and substantially uniformly distributed.

A hashing function is an example of such a function.

Note here that a hashing function is a mathematical function which causes the values of a large or potentially very large set of values to correspond to a more reduced range of values. More precisely, a word of n bits at the input will supply at the output a word of m bits where m is very small relative to n. Moreover, each bit of the output is advantageously a function of all the input bits with equal weighting.

In order to make the implementation of the hashing function secret, one solution consists in slightly modifying it for example by replacing one logic operator of the hashing function with another logic operator and burying this modified logic gate, and even all of the elements forming the hashing function within other logic circuits, commonly called “glue logic” by those skilled in the art.

As an indication, it is possible to choose, for example, a hashing function of the SHA-1, SHA-2 or MD5 type well known to those skilled in the art and modified for example as indicated above.

Note here that a known function using a secret variable or datum is sensitive to DPA attacks.

However, in the present case, the hashing function is structurally modified in a secret manner. Consequently, this hashing function is not sensitive to DPA attacks.

Moreover, since one and the same datum D generates one and the same stimulus ST, it becomes useless for an attacker even by reiterating an encryption operation a very large number of times by using the same input datum, to carry out averaging operations during the encryption process in order to obtain an averaged stimulus ST which would be linked to the hashing function.

Specifically the only result that an attacker could obtain with such an averaging would be a trace in current possibly with no signal noise but in any case would not make it possible to characterize this modified hashing function. A “template attack” then becomes very ineffective.

Although it is possible to use a modified hashing function, it is also possible to use, within the generation means, another encryption algorithm modified locally in a secret manner, for example an algorithm of the DES type or AES type with a secretly modified SBOX operator, using a secret key that would be buried in a protected memory. Here again one and the same input datum D will provide one and the same stimulus ST making a “template attack” ineffective. Moreover, since the modified structure of the encryption algorithm is unknown to a potential attacker it remains insensitive to DPA attacks.

This being so, the hashing function described above can have the advantage of being easier to produce in the component.

What is claimed is:

1. A secure method for cryptographic computation, comprising processing of an input datum by a cryptographic computation tool involving at least one encryption key and at least one generated item of secret information, so as to provide an output datum, characterized in that generation of said at least one generated item of secret information comprises processing of said input datum by at least one operator having at least one secret characteristic.

2. The secure method according to claim 1, in which said at least one operator comprises a function that is at least partially secret having an avalanche effect, and capable of providing respectively, based on different input variables, output variables that are independent and substantially uniformly distributed.

3. The secure method according to claim 1, in which the said operator comprises an at least partially secret hashing function.

4. The secure method according to claim 1, in which the processing of an input datum results from a modification of a known cryptographic computation tool, said modification involving said at least one generated item of secret information.

5. The secure method according to claim 1, in which the cryptographic computation tool comprises an encryption algorithm with a secret key of the DES or AES type.

6. An electronic component, comprising means for generating at least one item of secret information and means for cryptographic computation configured to receive an input datum and to deliver an output datum based on the input datum, on at least one encryption key and on said at least one item of secret information, characterized in that the means for generating comprises input means for receiving said input datum, output means for delivering to said means for cryptographic computation said at least one item of secret information, and at least one operator coupled between the input means and the output means and comprising at least one secret characteristic.

7. The electronic component according to claim 6, in which said at least one operator comprises an at least partially secret function having an avalanche effect and capable of providing respectively, based on different input variables, output variables that are independent and substantially uniformly distributed.

8. The electronic component according to claim 6, in which the said operator comprises an at least partially secret hashing function.

9. The electronic component according to claim 6, in which the means for cryptographic computation uses said at least one item of secret information to encrypt said input datum.

10. The electronic component according to claim 6, in which the means for cryptographic computation comprises an encryption algorithm with a secret key of the DES or AES type.

11. A smart card incorporating a component according to claim 6.

12. An electronic component comprising:
a first input for receiving an input datum;
a second input for receiving an encryption key;
a secret stimulus generator, configured to receive said input datum and to generate at least one item of secret information; and
an encryption engine, configured to receive said input datum, said encryption key, and said at least one item of secret information and to generate an encrypted datum therefrom by processing said input datum by at least one operation using said at least one item of secret information.

13. The electronic component of claim 12 wherein the encryption engine includes an encryption algorithm with a secret key of the type selected from the group consisting of DES and AES.

14. The electronic component of claim 12 wherein the secret stimulus generator operates on said input datum using an at least partially secret function having an avalanche effect.

15. The electronic component of claim 12 wherein the secret stimulus generator and the encryption engine are configured as part of a smart card.

16. The electronic component of claim 14 wherein the at least partially secret function is a hashing function.

17. The electronic component of claim 12 further comprising a protected memory.

18. The electronic component of claim 17 wherein the protected memory is configured to store a secret key.

19. The electronic component of claim 12 further comprising glue logic circuits and wherein portions of the secret stimulus generator are intermingled with the glue logic circuits.

20. The electronic component of claim 14 wherein the at least partially secret function is instantiated, at least in part, as a first logic circuit.

21. The electronic component of claim 20 where the first logic circuit is combined with glue logic circuits.
